(19) United States
(12) Patent Application Publication
(10) Pub. No.: US 2006/0027268 A1
(43) Pub. Date: Feb. 9, 2006

(54) Dosing device

(76) Inventor: Achim Philippe Zapp, Petite Rosselle (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/196,458

(22) Filed: Aug. 4, 2005

(30) Foreign Application Priority Data
Aug. 7, 2004 (FR) FR0451811

(51) Int. Cl. F16K 17/26

(52) U.S. Cl. 137/493.2

(57) ABSTRACT

The invention concerns a dosing device comprising a dosing tip (1) and a first valve (5) adapted to be opened or closed, this tip (1) being adapted to be fixed on a container, in particular a bottle, and an activator (20) adapted to be disposed on the dosing tip (1) in order to open the valve (5). The invention resides in that the activator (20) is equipped with a motor (22) to open the valve (5). A small motor disposed in the activator, in particular an electric motor supplied by a battery or an accumulator and which actuates the valve directly has a power consumption much lower than that of an electromagnetic system, such as those known in the state of the art, which has important leaks. It is preferable that the valve (5) is integral with a valve magnet (8) and that the activator (20) is equipped with a motor magnet (25) which can be displaced by the motor (22) to cooperate with the valve magnet (8) in order to open and/or to close the valve (5).

Dosing device comprising a dosing tip with a first valve that is adapted to be opened or closed, this tip being adapted to be fixed on a container, in particular a bottle, and a removable activator adapted to be disposed on the dosing tip in order to open the valve, the inside and the outside of the container being in communication when the first valve is open. The invention also concerns a dosing tip and an activator.

For dosing liquids, two systems are known in particular. The first comprises a dosing chamber which is in contact, on the one hand, with the inside of the container when a first valve is open, and which is in contact with the outside of the container when a second valve is open. To ensure the volume taken, the two valves cannot be opened simultaneously. To fill up the dosing chamber, the first valve is open, whereas the second valve is closed. At the latest during the taking, the first valve is closed and the second valve is opened to let the liquid contained in the dosing chamber flow out. This system makes it possible to dispense doses whose volume is predefined by the volume of the dosing chamber. The opening of the valves is ensured by an activator integral with the dosing device. As devices of the first group, those disclosed for example in documents FR 2 699 911 A1, WO 94/09346 A1, and AU 545 688 B2, will be mentioned.

The second system is constituted by a dosing tip comprising a conduit connecting the inside and the outside of the container, and in which is placed a valve that can be opened or closed. At the time of the taking, the valve is opened during a determined time during which the liquid flows directly from the bottle into the glass. The present invention relates to this type of dosing device.

As examples of this second type of dosing device, those cited in documents, on the one hand, DE 93 03 504 U1, DE 200 07 149 U1, U.S. Pat. No. 6,662,976 A and U.S. Pat. No. 6,036,055 A, and on the other hand, U.S. Pat. No. 5,379,916 A, will be mentioned. In the four first documents, the valve is opened by an electromagnet placed in an outside activator, which is in certain cases removable, in the fifth, the valve is opened by a mechanical device integral with the dosing tip and which is partially immersed in the flowing liquid.

The device of U.S. Pat. No. 6,036,055 A, for example, is constituted by, on the one hand, a dosing tip which is fixed on the neck of the bottle, and by a activator collar which is placed around the dosing tip. The dosing tip is equipped with a valve which, in a resting position, is pushed back by a spring against the opening through which the liquid flows. No liquid can be taken, even when the bottle is turned upside down. The valve is made in part in a magnetic steel. The activator collar is equipped with a coil wound around the orifice into which the dosing tip and thus the valve protrude. To trigger the opening of the valve, the barman lets current pass through the coil during a given time, which triggers the displacement of the coil and frees the opening of the dosing tip. An electronic device transmits to a base the information regarding the taking: name of the barman, name of the liquid, quantity taken, etc. This device makes is possible to ensure a regular dosing of drinks and to attribute the various doses to different waiters, as well as to manage drink supplies and consumption. The drawback of this device resides in the fact that it uses an electromagnet. The activator collar is thus heavy, bulky, and requires a high amount of energy.

The dosing device of DE 200 07 149 U1 comprises a dosing tip fixed on the bottle and a fixed support that supports the bottle with its dosing tip and under which the glass to be filled is placed. This installation has thus a certain size and the liquid can be poured only at the location where the fixed support is placed.

From document U.S. Pat. No. 6,662,976 A, a dosing device is known with a valve that is actuated when it is placed in an electric field.

A drawback of all the devices equipped with a valve that can be opened by means of an electromagnet is the relatively high power consumption to actuate the electrovalve, because it is necessary to actuate the valve against the force of a spring by means of an electromagnet. In addition, the size of these devices is often large and the devices are relatively heavy, which makes it thus difficult to use them at the bar. Finally, viscous drinks or drinks that tend to leave deposits lead to dysfunction of the spring systems relatively quickly. A drawback of the device of U.S. Pat. No. 5,379,916 A is that its motor is immersed partially in the flowing liquid, which is not desired for reasons of mechanical operation and well as hygiene.

The objective of the present invention is thus to propose a dosing device of the type presented in the preamble, which has a low power consumption and thus a large autonomy. In addition, the device of the invention must be reliable, not bulky, and light. Moreover, the liquid must not come in contact with the opening and closing mechanism. Further, the activator must be capable of being used for several containers.

This objective is met according to the invention, since the activator is equipped with a motor to open the valve. A small motor disposed in the activator, in particular an electric motor supplied by a battery or an accumulator and which actuates the valve directly has a power consumption much lower than that of an electromagnetic system, which has quite high losses.

The air intake can be through a small orifice on the side of the dosing tip. This is sufficient in particular when the container is stored mainly upright, i.e., with the dosing tip toward the top. If, on the contrary, the container is stored upside down, there is a risk that leaks would occur through the air intake orifice. It is thus preferable to equip the dosing tip with closing means. In a preferred embodiment of the invention, the dosing tip is equipped with a second valve that is adapted to be opened by the motor. This second valve will operate to let air enter during the taking. The first and the second valve will open and close preferably simultaneously.

Within the framework of the invention, it is envisioned to equip the activator with means for triggering closing of the first valve and/or of the second valve after a defined time has lapsed. Knowing the flow by time unit, it is possible to effect a dosing operation as a function of the duration of the opening of the first, and possibly of the second valve.

An improvement to the invention consists in providing an inclination sensor to activate the motor. The opening of the bottle being useful only when it is sufficiently inclined, the inclination sensor makes it possible to start the dosing operation by activating the motor.

In a preferred embodiment of the invention, the first valve and/or the second valve are integral with a first valve magnet and/or a second valve magnet, respectively, and the activator is equipped with a first motor magnet and/or with a second motor magnet which are adapted to be moved by the motor to cooperate with the first valve magnet and/or with the second valve magnet, respectively, in order to open and/or close the first valve and/or the second valve, respectively.

In order to ensure that the valves return to closed position, it is preferable to provide a first spring and/or a second spring, which tend to push the first valve and/or the second valve, respectively, to the closed position when the motor does not open them.

In a preferred embodiment of the invention, the first motor magnet and/or the second motor magnet are disposed in the activator so as to be moved each between a resting position where they do not trigger the opening of the first valve and/or the second valve, respectively, and an opening position where they cooperate with the first valve magnet and/or the second valve magnet, respectively, so as to trigger the opening of the first valve and/or the second valve, respectively, the first and the second motor magnets being preferably integral.

In order to determine the amount of liquid to be dispensed, it is possible to equip the dosing tip with means for identifying the container and/or the drink contained in the container, these identification means being adapted to transmit information regarding the container and/or the drink. This information can concern, for example, the type of drink, the initial volume of the bottle and the volume of a dose, as well as the amount taken, which makes it possible to indicate the volume of drink remaining in the bottle.

In an alternate embodiment of the invention, means for identifying the waiter are provided, these means being adapted to transmit information regarding the waiter. These means can be a mechanical or electronic key and they make it possible to know which waiter has served which amount of each drink. The accounting at the end of duty is thus facilitated.

To facilitate management of supplies and invoicing, it is possible to equip the activator with a control unit adapted to receive information from a base station, and/or to receive or read information from the means for identifying the waiter, and/or to receive or read information from the means for identifying the container and/or the drink, and to regulate the opening time of the first valve and/or of the second valve as a function of the information coming from the base station and/or the means for identifying the waiter and/or the means for identifying the container and/or the drink, and/or to be equipped with means for transmitting the information regarding the waiter, the drink, the container and/or the opening time of the first valve and/or of the second valve to the base station. Reading from the means for identifying the container and/or the drink makes it possible, on the one hand, to serve the doses designed for each drink, and on the other hand, to make cocktails from stored recipes, the device making it possible to adequately dose each ingredient of the recipe. Moreover, reading from the means for identifying the waiter can be used among others for the personal accounting of the waiters, for a control of employees and for management of supplies. With a control unit capable of communicating with the base, it is also possible to block the activator of some waiters, either in a general manner, or in a targeted manner for some drinks. It is also possible to set the dosing device in a “happy hour” mode or to authorize the pouring of liquid only after the order has been registered in a cash register.

The motor is preferably an electric motor supplied by batteries or a rechargeable accumulator placed in the activator. Small electric motors can be supplied by these means and have a good autonomy. They are light and not bulky. In particular, they require less space than the electromagnets and their weight as well as their consumption are lower. For dosing devices with double valve designed to be placed in a support upside down, it is also possible to supply the motor from the grid.

Finally, it is provided that the transmission of information between the dosing tip and the control unit as well as between the control unit and the base station is a wireless transmission. This measure, which avoids cables, makes it much easier to work with the dosing device.

The invention also concerns a dosing tip for a dosing device according to the invention, the dosing tip being equipped with a first valve adapted to be opened by the activator of the dosing device, thus making it possible, when the valve is open, to let a liquid flow through the dosing tip. In the tip according to the invention, the first valve is equipped with means for cooperating with a motor placed in the activator. When the tip is used on a container designed to be stored upside down, it is preferred to equip the tip with a second valve equipped with means for cooperating with the motor of the activator of the dosing device in order to open it.

These means for cooperating with a motor of the first valve and/or of the second valve are constituted preferably of a first valve magnet and/or of a second valve magnet, respectively, designed to cooperate with a first motor magnet and/or with a second motor magnet, respectively actuated by the motor, as well as of a first spring and/or of a second spring, respectively, which tend to maintain the first valve and/or the second valve, respectively, closed, when the first motor magnet and/or the second motor magnet, respectively, are in resting position.

The invention also concerns a removable activator for a dosing device according to the invention. The activator is equipped with a motor which is preferably equipped with one or two magnets adapted to be moved by the motor, preferably in an integral manner, in order to open a first valve and/or a second valve, respectively, of a dosing tip according to the invention.

Examples of applications of the invention will be described below in reference to the drawings which show:

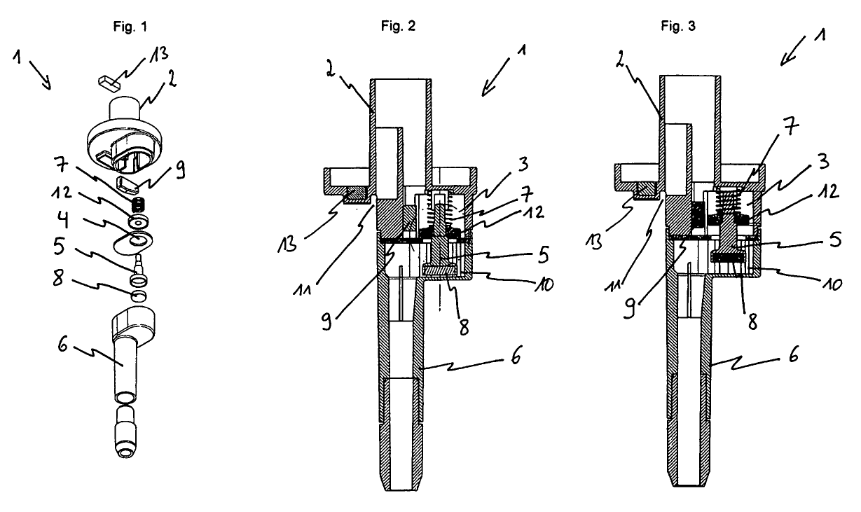

FIG. 1 an exploded view of a simple dosing tip;

FIG. 2 a front view in longitudinal cross-section of the dosing tip of FIG. 1 with the valve in closed position;

FIG. 3 a front view in longitudinal cross-section along line AA of FIG. 9 of the dosing tip of FIG. 1 with the valve in open position;

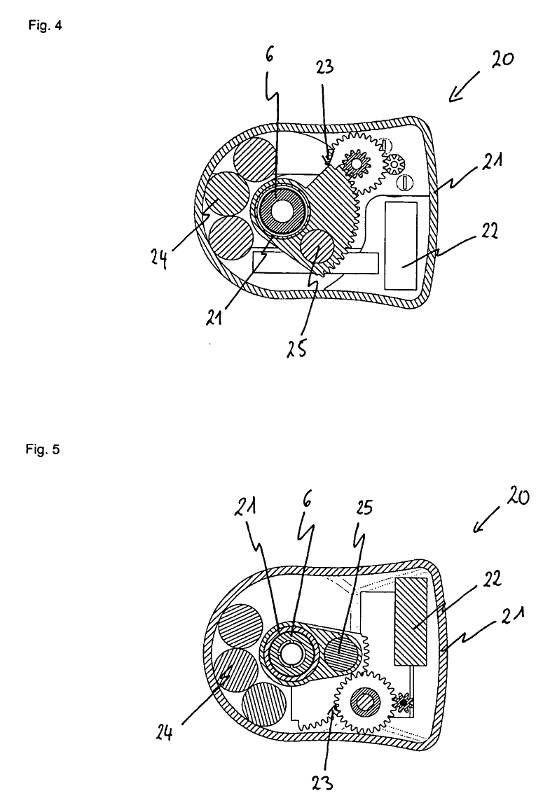

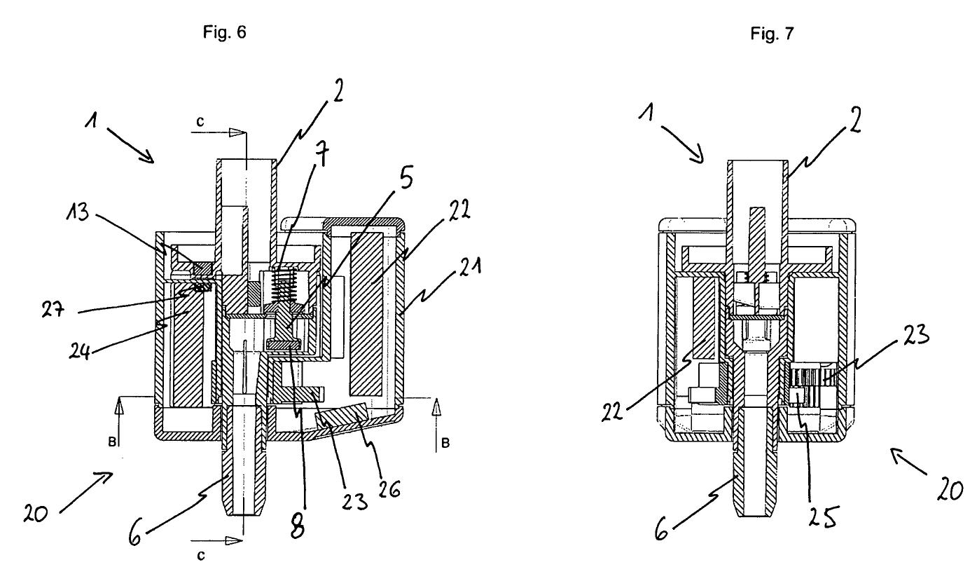

FIG. 4 a view from below along line BB on FIG. 6 of an activator slipped on a dosing tip in closed position;

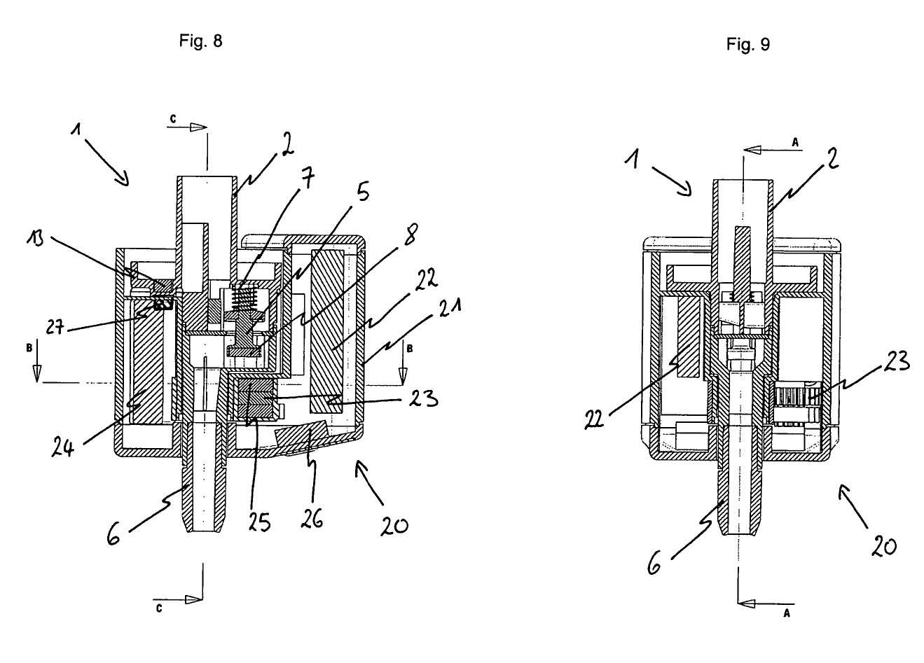

FIG. 5 a top view along section BB of FIG. 8 of an activator slipped on a dosing tip in opened position;

FIG. 6 a front view in longitudinal cross-section of a device according to the invention in closed position;

FIG. 7 a side view in cross-section along line CC of FIG. 6 of the device of FIG. 6;

FIG. 8 a front view along line AA of FIG. 9 of a device according to the invention in opened position;

FIG. 9 a side view along line CC of FIG. 8 of the device of FIG. 8;

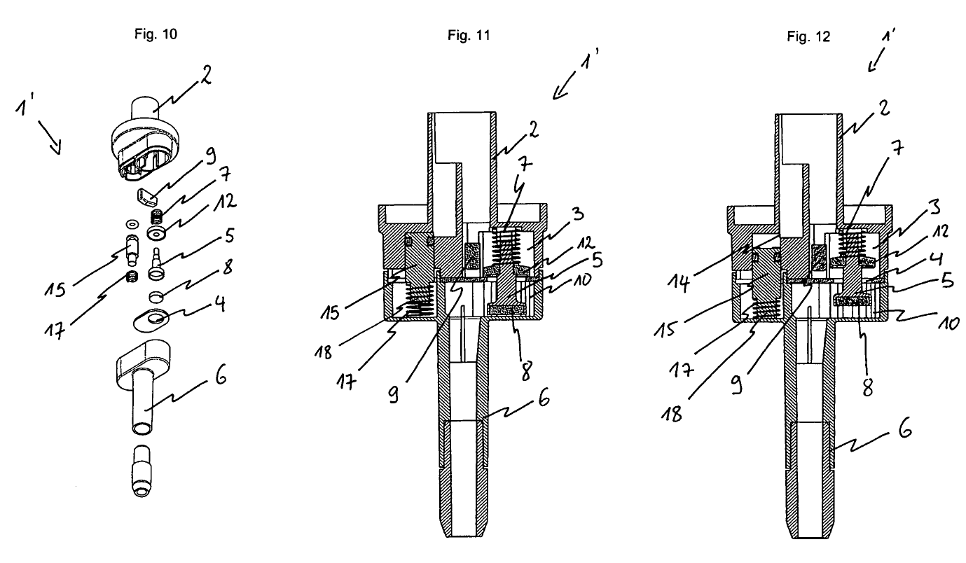

FIG. 10 an exploded view of a double valve;

FIG. 11 a front view in cross-section of the dosing tip of FIG. 10 in closed position; and

FIG. 12 a front view in cross-section of the dosing tip of FIG. 10 in opened position.

The dosing device consists essentially of a dosing tip (1, 1′) and an activator (20). In a first embodiment of the invention, the dosing tip (1) is equipped with a single valve (5), whereas in a second embodiment of the invention, it is equipped with two valves (5, 15). The second embodiment (1′) being directly derived from the first (1), it will be presented after the system with simple valve (1, 20).

The simple dosing tip (1), such as shown on FIGS. 1 to 9, is designed to be slipped on the neck of a bottle through the end piece (2). In order to avoid any fraud, the dosing tip is sealed on the bottle, for example, by means of a retractable cap. The hollow end piece (2) is open on the side of the bottle and opens into a first cavity (3) equipped with an orifice (4) closed by a valve (5) equipped with a cap (12). The orifice (4) sets the first cavity (3) in communication with a second cavity (10) opening into a spout (6) from which liquid flows when the valve (5) is opened. When the valve (5) is opened, there is thus communication between the inside and the outside of the bottle and liquid can flow freely through the dosing tip.

A first permanent magnet (8) is placed on the valve (5), for example, at its top. A first spring (7) tends to place the first valve (5) in closed position, the cap (12) obstructing the orifice (4). Thus, in resting position, the dosing tip is closed. Evaporation risks are thus avoided. Even when the bottle is turned upside down, the valve remains in closed position if no activator is put in place.

An orifice (11) at the base of the spout (6), opening into the end piece (2), makes it possible for air to penetrate into the container when liquid flows through the spout (6).

The dosing tip (1) is further equipped with means (9) for identifying the bottle and/or liquid that it contains. It is possible, thanks to these means, to detect which bottle or which liquid it is, and thus, to know the volume to be dispensed. These means for identifying the bottle and/or the liquid can be constituted by a bar code or by an RTIF transponder emitting the desired information.

The simple activator (20) is constituted essentially by a casing (21) in which are disposed an electric motor (22), a rack-and-pinion device (23), and a source of electric power (24), such as batteries, to supply the electric motor. During use, the activator (20) is slipped on the spout (6) of the dosing tip (1). A first permanent motor magnet (25) is disposed in the casing. It is integral with the rack-and-pinion device (23). It can move between two extreme position: a resting position, shown on FIGS. 4, 6, and 7, where it has no effect on the first valve magnet (8) or at least an effect too small to counter the force of the spring (7), and an opening position, shown on FIGS. 5, 8, and 9, in which it is practically aligned with the first valve magnet (8). In this position, it pushes back the first valve magnet (8) and thus the valve (5). The orifice (4) is then opened and the liquid can flow into the spout (6). During its displacement, the first motor magnet (25) follows a circular arc of about 40° around the spout (6).

It is to be noted, to properly understand FIGS. 4 and 5 which show the rotational movement of the first motor magnet (25) between the resting position (FIG. 4) and the opening position (FIG. 5), that FIG. 4 shows a cross-section view from below along line BB of FIG. 6, whereas FIG. 5 shows a cross-section view from above along line BB of FIG. 8. This explains that the rack-and-pinion system in particular is seen from below and from above.

The activator (20) is also equipped with a control unit not shown, which is capable of identifying the drink contained in the bottle by cooperating with the means (9) for identifying the bottle and/or the liquid that it contains. It can be, for example, a bar code reader or a RTIF receptor that will receive the signal from the RTIF transponder (9) disposed on the dosing tip (1). The control unit will determine the duration of the opening of the first valve (6) as a function of the information provided by the means (9) for identifying the bottle and possibly of the cocktail to be prepared. The activator can also be equipped with two contacts to select a dose. There are then three doses available: a “normal” dose that will be activated automatically, or a larger does or a smaller dose depending on the choice of contact button.

The triggering of the opening of the first valve (5), i.e., the activation of the electric motor, can be caused in different ways. The user can push on a switch that sends a signal to the control unit, the latter then triggering the opening of the first valve (5) by moving the first motor magnet (25) until it is aligned with the first valve magnet (8). It is also possible to place an inclination sensor on the activator (20). As soon as a threshold value is reached, the sensor sends a signal to the control unit.

Means (26) for identifying the user of the activator (20) can also be provided. For example, an activator (20) can be provided for each user, for example, for each barman. The user will slip his activator on the dosing tip of each bottle from which he will want to take a dose. Another solution consists in equipping each bottle with an activator (20), and each user identifies himself, for example, by means of a key or a card, at the time of the taking.

Thanks to wireless emission means, the control unit of the activator (20) can send to a central base all the information necessary to a good management of supplies. It will thus be possible to send the identifier of the user, the identifier of the bottle and/or of the liquid, as well as the duration of the taking. The central base then collects all this information, so that it is possible to know at any time the state of the supplies and the state of the sales by each barman. In addition, this data can be used for invoicing. It is also possible to equip the activator, not with a simple transmitter, but with a transceiver thanks to which it can communicate with the base station.

In the example presented here, the valve is controlled by means of a set of magnet (8, 25) and of a spring (7). The cap (12) of the valve (5) is disposed on the face of the orifice (4) located on the side of the first orifice (3), i.e., on the side of the end piece (2) and of the bottle. The valve (6), to open the orifice (4), must thus be pushed back in the direction of the end piece (2). The first motor magnet (25) is disposed on the side of the valve located toward the spout (6). It is thus required that the magnets (8, 21) be aligned by presenting two identical poles (i.e., North/North or South/South) to trigger the displacement of the valve (5). However, it would be completely possible to envision placing the cap of the valve in the second cavity (10) with a spring (7) designed, either to pull or push the valve (5), in both cases in the direction of the end piece (2). It would then be required that the second magnet (25) attracts the valve in the direction of the spout (6). Consequently, the magnets (8, 21) would need to be oriented so as to present two opposed poles (i.e., North/South or South/North).

Similarly, it is also possible to position the first motor magnet, not on the side of the valve located toward the spout (6), but on the side located on the side of the end piece (2) and of the bottle. The orientation of the magnets is then reversed with respect to the cases envisioned above.

Instead of triggering the opening of the valve (5) by moving a first motor magnet (25) with respect to a first magnet (8) integral with the valve (5), the motor could act directly on the valve (5), for example, by means of a rod extending from the valve (5). The spring (7) could then be eliminated, the motor ensuring the opening as well as the closing of the valve (5).

To ensure the fixation of the activator (20) on the dosing tip (1) and prevent it from sliding during pouring, a steel piece (13) is provided in the dosing tip (1) and a fixation magnet (27) is provided in the activator (20). The weight of the activator is sufficiently low so that the magnetic force applied by the fixation magnet (27) on the steel piece (13) is sufficient to maintain the activator in position during pouring of the liquid. This force is, however, small enough to be easily countered by hand, when the waiter wants to take his activator back after pouring. It is self-evident that the steel piece can be placed on the activator and the fixation magnet in the dosing tip. Similarly, other reversible fixation devices can be envisioned, such as clipping systems.

This simple dosing tip (1) with one valve (6) is more particularly designed for bottles that are stored with the dosing tip oriented upward. No liquid can come out of the bottle if it is turned upside down without the activator being triggered. However, the orifice for air entry (11) represents over a long time a source of leaks if the bottle is maintained upside down for too long a time. It is thus preferable to provide means for air entry that can be hermetically closed when no liquid is being taken.

The second embodiment of the invention thus provides a dosing tip (1′) equipped with two valves (5, 15), the first (5) being designed to let the liquid flow and the second (15) being designed to let air pass during the taking.

This second valve (15) is substantially identical to the first (5): it is equipped with a second valve magnet (18) and with a second spring (17) which tends to keep it closed.

The corresponding activator, the double activator, comprises all the pieces of the simple activator (20, plus a second motor magnet disposed preferably on the same rack-and-pinion device (23), opposed from the first motor magnet (25). Thus, in resting position, the two motor magnets are too far from the two valve magnets (8, 18) to trigger the opening of the two valves (5, 15). This is a situation like that shown partially on FIG. 4. When the motor starts, it moves the two motor magnets simultaneously to align them with the two valve magnets (8, 18) with which they interact so as to trigger the opening of the two valves (5, 15). This is the situation shown partially on FIG. 11, situation similar to that of FIG. 5. The liquid then flows through the spout (6) while the air is drawn into the bottle by passing through the second orifice (14) freed by the second valve (15). After a defined lapse of time, the motor brings the motor magnets back to their initial positions and the springs (7, 17) bring the valves (5, 15) back to the closed position, as on FIG. 10.

It is self-evident that the second valve can also be activated only by the aspiration force due to the underpressure that forms in the bottle during the taking of the liquid.

Further, the two motor magnets can be non-integral with each other and can have non-simultaneous displacements. In addition, the previous considerations regarding the position of the first valve with respect to its orifice and thus the orientation of the poles of the valve and motor magnets are applicable in the same manner to the second valve.

The double dosing tip (1′) and the double activator can also be equipped, one with a steel piece, and the other with a fixation magnet, or with any other reversible fixation device, like the simple dosing device.

The advantage of the dosing device according to the invention is that the displacement of the magnet requires only a small force that will be supplied without difficulty by a miniaturized electric motor. The power consumption by taking is thus very low. It is consequently possible to work with batteries or accumulators without it being required to change or to recharge them too often. The low weight of the motor and of the required batteries makes the device conform to the invention much lighter and compact than those using the electromagnet technology. In addition, thanks to the use of batteries and radio transmission devices, it is possible to use the nomadic dosing device within a large range, which can reach at least 20 meters nowadays with current systems.

### LIST OF REFERENCE NUMERALS

1. Dosing tip
2. End piece
3. First cavity
4. Orifice of the cavity
5. First valve
6. Spout
7. First spring
8. First valve magnet
9. Bottle identifier
10. Second cavity
11. Air entry orifice
12. Valve cap
13. Steel piece
14. Second orifice
15. Second valve
17. Second spring
18. Second valve magnet
20. Activator
21. Casing
22. Motor
23. Rack-and-pinion device
24. Power source
25. First motor magnet
26. User identification means
27. Fixation magnet

1. Dosing device comprising a dosing tip with a first valve adapted to be opened or closed, this tip being adapted to be fixed on a container, in particular a bottle, and a movable activator adapted to be disposed on the dosing tip in order to open the valve, the inside and the outside of the container being in communication when the first valve is opened, wherein the activator is equipped with a motor for opening the valve.

2. Device according to the previous claim, wherein the dosing tip comprises a second valve, said second valve being adapted to be opened by the motor.

3. Device according to claim 1, wherein the activator is equipped with means for triggering the closing of the first valve and/or of the second valve after a defined lapse of time.

4. Device according to claim 1, wherein an inclination sensor is provided to activate the motor.

5. Device according to claim 1, wherein the first valve and/or the second valve are integral with a first valve magnet and/or with a second valve magnet, respectively, and the activator is equipped with a first motor magnet and/or with a second motor magnet which can be displaced by the motor to cooperate with the first valve magnet and/or the second valve magnet, respectively, in order to open and/or to close the first valve and/or the second valve, respectively.

6. Device according to claim 1, wherein a first spring and/or a second spring are provided, which tend to push the first valve and/or the second valve, respectively, back toward the closed position when the motor does not open them.

7. Device according to claim 5, wherein the first motor magnet and/or the second motor magnet are disposed in the activator so as to be displaced each between a resting position where they do not trigger the opening of the first valve and/or of the second valve, respectively, and an opening position where they cooperate with the first valve magnet and/or with the second valve magnet, respectively, so as to trigger the opening of the first valve and/or of the second valve, respectively, the first motor magnet and the second motor magnet being preferably integral.

8. Device according to claim 1, wherein the dosing tip is equipped with means for identifying the container and/or the drink contained in the container, these means for identifying the container and/or the drink being adapted to emit information regarding the drink and/or the container.

9. Device according to claim 1, wherein the activator is equipped with means for identifying the waiter, these means for identifying the waiter being adapted to emit information regarding the waiter.

10. Device according to claim 8, wherein the activator comprises a control unit adapted to receive information from a base station, and/or to receive or read the information from the means for identifying the waiter, and/or to receive or read the information from the means for identifying the container and/or the drink, and to regulate the duration of the opening of the first valve and/or of the second valve as a function of the information coming from the base station and/or from the means for identifying the waiter and/or from the means for identifying the container and/or the drink, and/or to be equipped with means for transmitting the information regarding the waiter, the drink, the container and/or the duration of the opening of the first valve and/or of the second valve to the base station.

11. Device according to claim 1, wherein the motor is an electric motor supplied by batteries or an accumulator disposed in the activator.

12. Device according to claim 1, wherein the transmission of information between the dosing tip and the control unit as well as between the control unit and the base station is a wireless transmission.

13. Dosing tip for a dosing device according to claim 1, the dosing tip being equipped with a first valve adapted to be opened by the activator of the dosing device, a liquid being capable of flowing through the dosing tip when the valve is opened, wherein the first valve is equipped with means for cooperating with a motor disposed in the activator.

14. Dosing device according to claim 13, which comprises a second valve equipped with means for cooperating with the motor of the activator of the dosing device in order to open it.

15. Dosing device according to claim 13, wherein the means for cooperating with a motor of the first valve and/or of the second valve are constituted by a first valve magnet and/or by a second valve magnet, respectively, adapted to cooperate with a first motor magnet and/or with a second motor magnet, respectively actuated by the motor, and possibly by a first spring and/or by a second spring, respectively tending to maintain the first valve and/or the second valve, respectively, closed when the first motor magnet and/or the second motor magnet, respectively, are in resting position.

16. Removable activator for a dosing device according to claim 1, which is equipped with a motor.

17. Activator according to claim 16, which is equipped with two motor magnets adapted to be displaced by the motor, preferably integrally.
